(19) United States
(12) Patent Application Publication
(10) Pub. No.: US 2025/0124883 A1
(43) Pub. Date: Apr. 17, 2025

(54) DISPLAY SYSTEM AND BACKLIGHT CONTROL METHOD THEREOF

(71) Applicant: AUO Display Plus Corporation, Hsinchu City (TW)

(72) Inventors: PO-KUN CHEN, Hsinchu City (TW); YU-CHIEN TSENG, Hsinchu City (TW); HUI-LUNG LU, Hsinchu City (TW); REN-WEI HUANG, Hsinchu City (TW)

(21) Appl. No.: 19/002,731

(22) Filed: Dec. 27, 2024

(30) Foreign Application Priority Data
Dec. 5, 2024 (TW) 113147317

(51) Int. Cl. G09G 3/34; G02B 23/24

(52) U.S. Cl. CPC G09G 3/3406; G02B 23/2484; G09G 2320/062; G09G 2320/0646

(57) ABSTRACT

The invention provides a backlight control method for a display system. The display system has a backlight module, and a light-emitting surface of the backlight module is divided into a plurality of light-emitting areas, and each light-emitting area corresponds to at least one light-emitting unit. The backlight control method includes the following steps: receiving an input image data from the display module of the display system; performing a local dimming procedure on the backlight module according to the input image data, wherein the light-emitting unit corresponding to each light-emitting area has a local dimming value; obtaining area peak luminance of each light-emitting area; determining a compensation area peak luminance of each light-emitting area according to a brightness enhancement comparison table and the peak brightness values of the light-emitting areas; and applying each compensation area peak luminance to each corresponding light-emitting area of backlight module.

### FIELD OF THE INVENTION

The present invention relates to a display system and a backlight control method thereof, and more particularly to a medical display system and a backlight control method thereof.

### BACKGROUND OF THE INVENTION

Endoscopes are more and more widely used in the medical field, particularly in surgery. The basic structure of each endoscope is such that an LED lamp is disposed at the front end of a lens to provide lighting, and thus doctors can perform observation and operations in narrow human body cavities with insufficient light. However, due to limited light-emitting distances, with regard to images obtained by the endoscopes, only the portions (close shots) close to the lenses have the good light-emitting effect, and the remote portions (long shots) are relatively dim. Such image quality problems may cause difficulties to diagnoses and operations of the doctors.

With regard to the above problems, known solutions are to perform calculations mainly based on the luminance of the entire images and then perform adjustment. Specifically, a known backlight adjustment and control method includes performing overall luminance increase on an entire image frame such that the dim long shots have the high luminance, in this way, the original bright close shots are overexposed, and the difficulties in interpretations are also caused.

Thus, how to provide a display system and a backlight control method thereof is actually one of the important issues at present.

### SUMMARY OF THE INVENTION

The present invention provides a display system and a backlight control method thereof, so as to cope with independent backlight control corresponding to a specific area of an image frame, thereby improving the luminance difference between a close shot and a long shot in an image.

To achieve the above purpose, the present invention provides a backlight control method for a display system. The display system includes a backlight module, a light-emitting surface of the backlight module is divided into a plurality of light-emitting areas, and each of the light-emitting areas corresponds to at least one light-emitting unit. The backlight control method includes the following steps: receiving input image data by a display module of the display system; performing a local dimming procedure on the backlight module according to the input image data, where the light-emitting unit corresponding to each of the light-emitting areas has a local dimming value; obtaining area peak luminance of each of the light-emitting areas; determining compensation area peak luminance of each of the light-emitting areas according to a luminance enhancement comparison table and the corresponding area peak luminance of the light-emitting areas; and applying the compensation area peak luminance to each of the corresponding light-emitting areas of the backlight module.

In an embodiment of the present invention, the luminance enhancement comparison table includes compensation area peak luminance corresponding to different area peak luminance ranges.

In an embodiment of the present invention, when the area peak luminance is in a range of 10-20%, the corresponding compensation area peak luminance is in a range of 50-70%.

In an embodiment of the present invention, a display image corresponding to the input image data has at least one bright area and at least one dark area distributed. The bright area is distributed as an annular bright area, and the dark area is distributed as a central dark area.

In an embodiment of the present invention, the local dimming procedure includes compensation for a local dimming value corresponding to the dark area on the basis of the halo degree of the dark area.

In an embodiment of the present invention, the compensation area peak luminance is calculated as a product of the area peak luminance and a luminance adjustment ratio.

Besides, to achieve the above purpose, the present invention provides a display system, including a display module, a backlight module and a driving unit. The display module receives input image data. The backlight module includes a light-emitting surface divided into a plurality of light-emitting areas, where each of the light-emitting areas is correspondingly provided with at least one light-emitting unit, and the light-emitting unit corresponding to each of the light-emitting areas has a local dimming value. The driving unit is coupled to the display module and the backlight module respectively, the driving unit performs a local dimming procedure on the backlight module according to the input image data, and applies a plurality of compensation area peak luminance to the corresponding light-emitting areas of the backlight module. The compensation area peak luminance is obtained according to a luminance enhancement comparison table and corresponding area peak luminance of each of the light-emitting areas.

In an embodiment of the present invention, each of the local dimming values is determined on the basis of the halo degree of the dark area.

As stated above, according to the display system and the backlight control method thereof in the present invention, luminance compensation adjustment is performed on a specific luminance interval by means of the luminance enhancement comparison table. When the present invention is applied to a medical endoscope display system, luminance compensation can be separately performed on a dark specific area, thereby facilitating interpretations of display images by medical workers.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 shows a structural schematic diagram of a display system according to a preferred embodiment of the present invention;

FIG. 2 shows a structural schematic diagram of a display device according to a preferred embodiment of the present invention;

FIG. 3 shows a layout zoning schematic diagram of light-emitting units of a backlight module in the present invention;

FIG. 4 shows a schematic diagram of light-emitting areas of the backlight module in the present invention;

FIG. 5 shows a flow diagram of a backlight control method according to a preferred embodiment of the present invention;

FIG. 6 shows a schematic diagram of a display image corresponding to input image data; and

FIG. 7 shows a schematic diagram of a luminance enhancement comparison table.

### DETAILED DESCRIPTION OF PREFERRED EMBODIMENTS

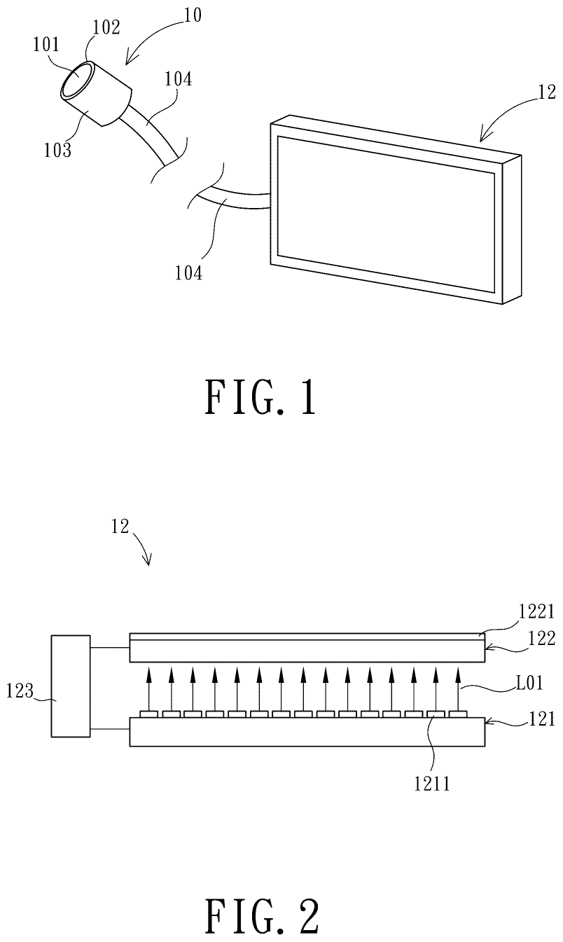

Reference is made to FIG. 1. A display system according to a preferred embodiment of the present invention is an endoscope display system used in the medical field and includes an endoscope assembly 10 and a display device 12. The endoscope assembly 10 includes a lens module 101, a light-emitting module 102, a housing 103 and a transmission line 104. The display device 12 includes a backlight module 121, a display module 122 and a driving module 123.

In the endoscope assembly 10, the lens module 101 and the light-emitting module 102 are accommodated in the housing 103 and are electrically connected to the transmission line 104. The transmission line 104 can transmit power, image signals and driving signals unidirectionally or bidirectionally, which are not limited here. The light-emitting module 102 is, for example, a light-emitting diode, and can be embedded in the housing 103 and is located at the front end of the endoscope assembly 10, for example, it is annularly disposed around the lens module 101. The light-emitting module 102 provides a light source in the direction of an image capture range of the lens module 101.

Reference is made to FIG. 2. In the display device 12, the driving module 123 is coupled to the backlight module 121 and the display module 122, and can drive the backlight module 121 and the display module 122 respectively, so that light L01 emitted by the backlight module 121 passes through the display module 122 and then displays an image on a display panel 1221, and the dimming and compensation process of a light-emitting unit 1211 of the backlight module 121 is controlled.

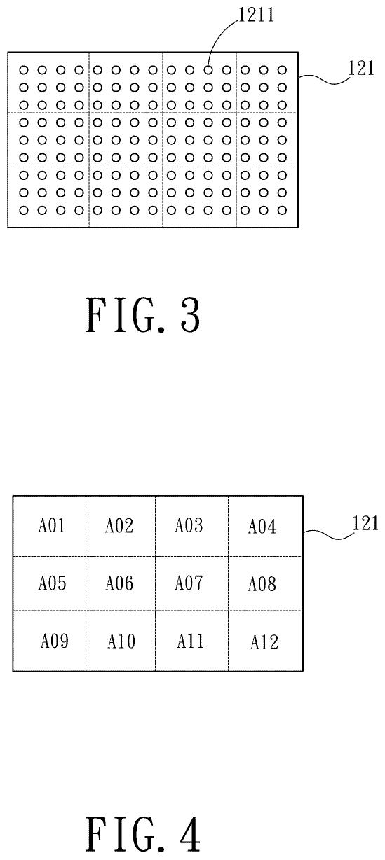

The backlight module 121 is a direct type backlight module. Reference is made to FIG. 3. The backlight module 121 includes a plurality of light-emitting units 1211 arranged in an array, for example, including but not limited to light-emitting diodes (LEDs), organic light-emitting diodes (OLEDs), mini light-emitting diodes (mini-LEDs) or micro light-emitting diodes (micro-LEDs). The mini-LEDs are taken as examples in this embodiment. The array type arrangement means that the light-emitting units 1211 are arranged and combined in rows and columns, and is not limited to aligned arrangement or staggered arrangement. Reference is made to FIG. 3 and FIG. 4 at the same time, the light-emitting units 1211 arranged in an array are divided into multiple groups, and each group forms a light-emitting area. In this embodiment, 12 light-emitting areas A01-A12 are taken as examples for illustration, but it is not restrictive. The units can also be divided into, for example, 512 light-emitting areas or 1024 areas, and each light-emitting area can even include only one light-emitting unit.

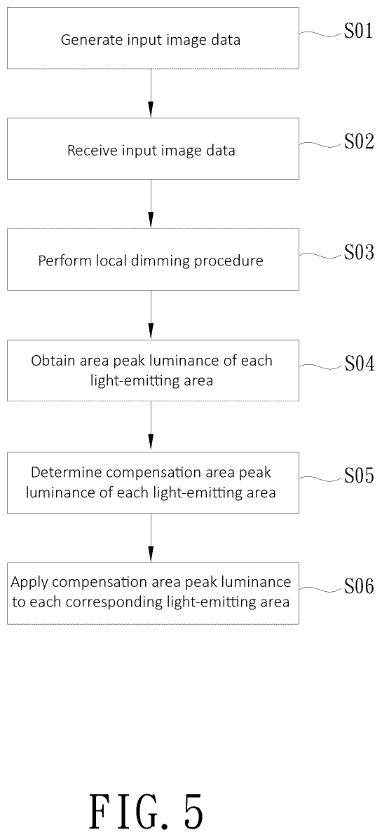

Next, reference is made to FIG. 1, FIG. 3, and FIG. 5 at the same time, so as to illustrate a backlight control method for the display system according to the preferred embodiment of the present invention. FIG. 5 shows a flow diagram of the backlight control method according to the preferred embodiment of the present invention. The backlight control method includes step S01 to step S06.

In step S01, the endoscope assembly 10 extends into a cavity to generate input image data and transmits same to the display device 12. In this embodiment, the endoscope assembly 10 can be operated by a doctor to extend into, for example, colorectal tissue. In the colorectal cavity, the light-emitting module 102 provides the light source for the front of the endoscope assembly 10, and the lens module 101 captures a corresponding image and then generates the input image data.

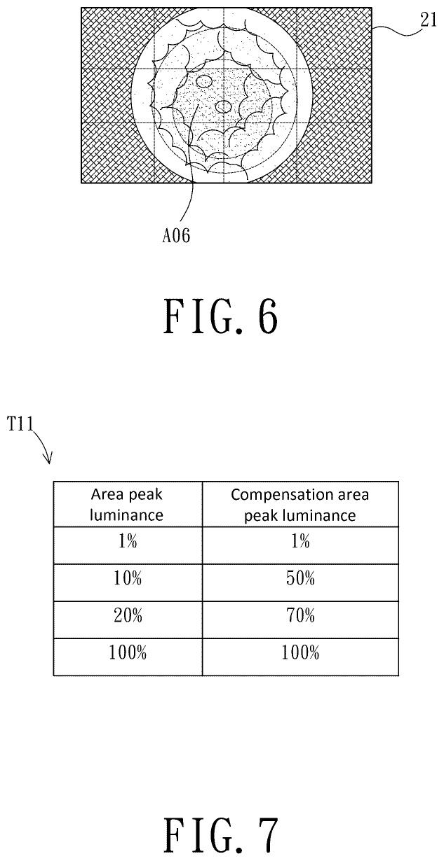

In step S02, the display module 122 of the display device 12 receives the input image data. A display image corresponding to the input image data has a bright area and a dark area distributed. In this embodiment, the light-emitting module 102 of the endoscope assembly 10 is annularly disposed around the lens module 101, after the endoscope assembly 10 extends into the colorectal cavity, it can be understood that as shown in FIG. 6, the close shot portion close to the lens module 101 is bright and clear due to more lighting, and the area of the image close to the center belongs to the long shot and receives less lighting, and therefore is shown as a dark image. As shown in FIG. 6, in this embodiment, the bright area is distributed as an annular bright area, and the dark area is distributed as a central dark area.

As shown in FIG. 5, in step S03, a local dimming procedure is performed on the backlight module 121 according to the input image data. The light-emitting unit 1211 corresponding to each of the light-emitting areas A01-A12 has a local dimming value. In this embodiment, the local dimming procedure is performed on the backlight module 121 according to the Gamma value (for example, Gamma 2.2) of the display device 12. The local dimming procedure includes independently adjusting the light-emitting luminance of each light-emitting unit 1211 by the backlight module 121 according to the luminance of each portion of the display image. Thus, the luminance of the corresponding light-emitting unit 1211 can be reduced when a dark image is displayed, thereby increasing the depth of the black color; and the luminance of the corresponding light-emitting unit 1211 can be increased when a bright image is displayed, thereby increasing the luminance of the image. The local dimming procedure can use an AmLED technology, and an active matrix driving circuit is used to control turning-on and turning-off of each mini-LED, or perform accurate luminance control on each light-emitting area. In other words, in this embodiment, the local dimming procedure is executed to compensate for gamma, and in different display areas, the Gamma value is maintained at 2.2 by adjusting the backlight luminance. Besides, the local dimming procedure further includes compensation for a local dimming value corresponding to the dark area on the basis of the halo degree of the dark area, thereby reducing the halo effect.

In step S04, the area peak luminance (APL) of each of the light-emitting areas A01-A12 is acquired. In the backlight module 121 of the display device 12, the area peak luminance of each of the light-emitting areas A01-A12 can be obtained by means of a photodetection assembly, for example, a photodiode. One or more photodetection assemblies can be provided, which is not limited here.

Step S05 is as shown in FIG. 7, compensation area peak luminance of each of the light-emitting areas is determined according to a luminance enhancement comparison table T11 and the corresponding area peak luminance of the light-emitting areas obtained in the above steps. In this embodiment, the luminance enhancement comparison table T11 includes compensation area peak luminance corresponding to different area peak luminance ranges, for example, when the area peak luminance is in a range of 10-20%, the corresponding compensation area peak luminance is in a range of 50-70%, and adjustment is avoided when the area peak luminance is 1% or 100%. In other words, in the luminance enhancement comparison table in the present invention, adjustment and compensation are only performed on some luminance intervals. The values of the area peak luminance and the compensation area peak luminance are only illustrative and are not restrictive.

In step S06, the compensation area peak luminance is applied to each of the corresponding light-emitting areas A01-A12 of the backlight module 121. In this embodiment, the compensation area peak luminance is calculated as a product of the area peak luminance of each of the light-emitting areas and a corresponding luminance adjustment ratio. For example, assuming that the area peak luminance of the light-emitting area A06 is 20%, the luminance adjustment ratio thereof can be 3.5, and the compensation area peak luminance of 70% can be obtained by multiplying.

In conclusion, according to the display system and the backlight control method thereof in the present invention, luminance compensation is performed on the specific luminance interval in the display image. Generally speaking, the close image has the good luminance performance due to the high lighting, and the distant image has the dark luminance performance due to the weak lighting. Thus, the distant image can also have the good image performance by means of luminance compensation of the specific luminance interval.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight control method for a display system, wherein the display system comprises a backlight module, a light-emitting surface of the backlight module is divided into a plurality of light-emitting areas, and each of the light-emitting areas corresponds to at least one light-emitting unit, and the backlight control method comprises:
receiving input image data by a display module of the display system;
performing a local dimming procedure on the backlight module according to the input image data, wherein the at least one light-emitting unit corresponding to each of the light-emitting areas has a local dimming value;
obtaining area peak luminance of each of the light-emitting areas;
determining compensation area peak luminance of each of the light-emitting areas according to a luminance enhancement comparison table and the corresponding area peak luminance of the light-emitting areas; and
applying the compensation area peak luminance to each of the corresponding light-emitting areas of the backlight module.

2. The backlight control method according to claim 1, wherein the luminance enhancement comparison table comprises compensation area peak luminance corresponding to different area peak luminance ranges.

3. The backlight control method according to claim 2, wherein when the area peak luminance is in a range of 10-20%, and the corresponding compensation area peak luminance is in a range of 50-70%.

4. The backlight control method according to claim 1, wherein a display image corresponding to the input image data has at least one bright area and at least one dark area distributed.

5. The backlight control method according to claim 4, wherein the bright area is distributed as an annular bright area, and the dark area is distributed as a central dark area.

6. The backlight control method according to claim 4, wherein the local dimming procedure comprises compensation for a local dimming value corresponding to the dark area on the basis of the halo degree of the dark area.

7. The backlight control method according to claim 1, wherein the compensation area peak luminance is calculated as a product of the area peak luminance and a luminance adjustment ratio.

8. A display system, comprising:
a display module, for receiving input image data;
a backlight module, comprising a light-emitting surface divided into a plurality of light-emitting areas, wherein each of the light-emitting areas is correspondingly provided with at least one light-emitting unit, and the at least one light-emitting unit corresponding to each of the light-emitting areas has a local dimming value; and
a driving unit, coupled to the display module and the backlight module respectively, wherein the driving unit performs a local dimming procedure on the backlight module according to the input image data, and applies a plurality of compensation area peak luminance to the corresponding light-emitting areas of the backlight module;
wherein the compensation area peak luminance is obtained according to a luminance enhancement comparison table and corresponding area peak luminance of each of the light-emitting areas.

9. The display system according to claim 8, wherein the light-emitting areas are divided into at least one bright area and at least one dark area, and the compensation area peak luminance is applied to the dark area.

10. The display system according to claim 9, wherein when the area peak luminance of the light-emitting areas is in a range of 10-20%, the corresponding compensation area peak luminance is in a range of 50-70%.

11. The display system according to claim 9, wherein the bright area is distributed as an annular bright area, and the dark area is distributed as a central dark area.

12. The display system according to claim 9, wherein each of the local dimming values is determined on the basis of the halo degree of the dark area.
